(19) United States
(12) Patent Application Publication
(10) Pub. No.: US 2008/0040178 A1
(43) Pub. Date: Feb. 14, 2008

(54) Method of assigning a set of resources to multiple agents

(75) Inventor: Frederic Armetta, Villeurbanne (FR)

Correspondence Address: BURR & BROWN, PO BOX 7068, SYRACUSE, NY, 13261-7068, US

(73) Assignee: OSLO, Lyon (FR)

(21) Appl. No.: 11/481,698

(22) Filed: Jul. 6, 2006

(51) Int. Cl. G05B 19/418

(52) U.S. Cl. 705/8

(57) ABSTRACT

A method of assigning a set of resources to multiple agents using the resources, including an initial stage, consisting in setting up a collaborative network between agents, which expresses all the relations between agents liable to share at least one given resource through one or more coordinated actions, the network evaluating a degree of satisfaction for each agent according to all the validity verdicts ascribed by each agent to the relations in which they are engaged, and a resolution stage including a series of iterative basic stages during which each agent: perceives a satisfaction rating ascribed to each relation by all the agents linked by the relation, alters the satisfaction rating, and validates or invalidates the relation in question, wherein the series of basic stages continues until a predefined state of resolution is achieved.

### BACKGROUND OF THE INVENTION

1. Technical Field

The invention relates to management methods for critical resources in multiagent systems, namely resources likely to be used by multiple agents. More specifically, it concerns a method for assigning such resources to different agents according to overall objectives. The method can be applied in a wide variety of fields, including industrial scheduling in a broad sense, but also in many organizational areas, spatial in particular.

By way of example, in industrial scheduling, a production line comprising several machines processing different products can be modelled using a multiagent system. In this type of system, the agents are the processing tasks for the various batches of manufactured products, and they share common resources, namely the uptime of the various production machines.

It is perfectly understandable that the more complex the production line and the more types of product need to be made, the more complex becomes the problem of finding a solution to sequencing the various tasks to be executed in a satisfactory order on all the machines.

In other words, multiagent systems require the implementation of methods that can determine what actions, coordinated between the various agents, can be used to achieve a global solution, one in which each agent performs one or more of the actions required to achieve that overall result.

One can understand that a number of choices or decisions to assign a given resource to such and such an agent must be made to achieve the global solution. The prerequisite for such decisions is a series of negotiations between agents likely to share a common resource.

To date, various models can be implemented to ensure that all negotiations between agents conclude in a satisfactory solution. Such models traditionally fall into two categories, reactive multiagent systems (or MAS) and cognitive MASs, depending on whether the performance of the negotiation process can be ascribed to collective behaviour based on interaction between agents behaving in a simple fashion, or to a sum of agent behaviours implementing elaborate individual reasoning capacities.

Existing resolution models based on reactive multiagent systems are ill-adapted to resolving the difficult problem of critical resource sharing, because in such models, multiple consecutive tasks are performed without any real consideration of their impact on the overall situation. As a result, the fact of correcting negative impacts can generate a multiplicity of contradictory actions for a given agent, who then runs the risk of being overloaded. The agents act at odds with one another, unable to coordinate their actions to achieve the desired overall objective. One of the aims of this invention is to better coordinate agents' reactive resolution processes in the field of shared critical resources by eliminating the aforesaid overload factor.

Another category of agent model benefits from more cognitive strategies. In such cognitive MAS models, one agent dialogues with several others, propagating a series of one-to-one negotiations before finding a satisfactory global solution. Indeed, the advantage of this solution is that a global solution (if one exists) can be found before any action is taken, because all the situations to be assessed can be reviewed more thoroughly in a cognitive manner. However, one of the major drawbacks of such cognitive models is the considerable length of time required to propagate the various negotiations and the inherent risk of deadlocks.

### SUMMARY OF THE INVENTION

One of the invention's aims is to alleviate the aforesaid drawbacks and work out a global solution by decentralizing negotiations between agents. Another of its aims is to achieve satisfactory overall solutions by limiting the risk of deadlock in the overall resolution process.

The invention therefore exposes a method of assigning a set of resources to a plurality of agents using them.

The initial stage of the method consists in designing a collaborative network between agents. The network expresses all the links between agents liable to share at least one given resource through one or more coordinated tasks. The network also allows each agent's satisfaction rating to be assessed according to all the validity verdicts each agent ascribes to the links affecting him.

The next stage, known as the resolution stage, can then commence; it consists of an iterative series of basic stages. During each of these basic stages, each agent perceives a satisfaction rating ascribed to each link by all the agents concerned; each agent then influences the said satisfaction rating by validating or invalidating the link in question. A validated link means that the agent agrees to its being part of the problem-solving process and therefore leading to the fulfillment of the corresponding coordinated tasks.

This succession of stages continues until a predefined state of resolution is reached.

In practice, the collaborative network can be represented by a heterogeneous graph, in other words one made up of various types of nodes, each representing distinct functions, such as agents or links etc. In this case, the trunk of a tree represents each agent, and all the various trees are interconnected by their leaves, thereby representing the links (or relationships) between the agents.

Depicting a collaborative network of agents as a graph can be appropriate for certain multiagent system configurations. One can also have linked trees sharing common parts, or sub-trees sharing sub-parts of the collaborative network.

In practice, the resolution process may persist until a predefined number of basic stages have been completed, or even until a predefined length of time has elapsed. The resolution process can also continue until a predefined proportion of agents are satisfied. Ideally, the resolution process should end when all the agents are satisfied, resulting in a global solution. But the resolution process may well end before a global solution is found, in particular if the latter does not exist.

In practice, the satisfaction ratings during the resolution process can change according to different principles. For instance, one can imagine that satisfaction ratings evolve iteratively according to a determinist function of the perceived ratings. In other words, this mechanism favours those links between agents that their respective agents consider rather satisfactory and recognize as valid. To put it another way, this mechanism reinforces the links already positively perceived by the agents. Favourable ratings can therefore propagate throughout the collaborative network.

Conversely, one can also imagine that satisfaction ratings evolve through a function including a random factor. In this case, each agent changes the satisfaction rating for a link not only in relation to the previous changes but also with the ability to impede this change thanks to the random factor. In particular, such a mechanism allows stages known as “exploratory stages” to be fulfilled, stages in which one avoids the genesis of local solutions that prevent the propagation of a global solution.

In practice, satisfaction ratings can also evolve according to a law based on the aims of assignment. By way of example, on an industrial production line, the assignment aims may be cutting production time or even power consumption. In accordance with the invention, this law can evolve over time, for instance if the aims evolve.

In practice, one can thus discern subsets of agents, all linked to one another by the relations showing positive validity verdicts for all the agents linked by this relation. In other words, one can identify patterns, namely areas of the network in which the agents are locally all satisfied, which therefore qualifies as a local solution.

### DESCRIPTION OF THE FIGURES

The manner in which the invention is implemented and its attendant advantages will become clear in the following description of the implementation method, reference being made to the appended figures, in which:

FIG. 1 is a set of timing diagrams illustrating the occupancy of several production machines by various production tasks considered as agents.

FIG. 2 is a graph illustrating the links between the different agents.

FIG. 3 is a set of timing diagrams showing the exchanges between the various tasks shown in FIG. 2.

FIG. 4 is a set of timing diagrams showing the results of the invention's resolution process.

FIGS. 5a to 5d are representations of a tree forming part of a collaborative network between agents, which show the various stages of the resolution process.

FIG. 6 is a simplified organization chart showing the invention's various stages.

### DESCRIPTION OF A FULFILLMENT METHOD

As we have already seen, the invention concerns a process whereby negotiations between different agents needing to share critical resources can be organized. This process applies to numerous applications, and the example described below, given purely for illustrative purposes, in no way limits the scope of the invention.

By the same token, the production planning example in question has been highly simplified to make the invention easier to understand, but needless to say, the benefits of the latter naturally reside in the solving of much more complex problems.

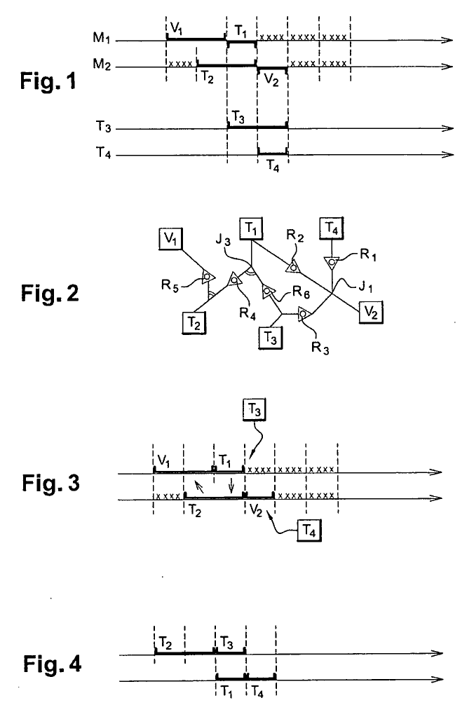

In the case illustrated by the industrial process scheduling figures, the various tasks to be accomplished are defined as “agents” needing to share common “resources”, namely the uptime of a machine on which the tasks need to be performed. The two top timing diagrams in FIG. 1 show the machine time required by tasks T₁ and T₂ respectively on machines M₁ and M₂. The tasks may vary in length and in sequencing constraints, a factor we have not illustrated for the sake of clarity, but such variable can be included in the process. As shown, task T₁ is preceded by task V₁, deemed an empty (or vacant) task, which represents machine downtime (vacancy). Similarly, a task V₂ follows task T₂ performed by machine M₂. Before and after these tasks T₁, T₂, V₁, V₂, the machines are busy and cannot perform other tasks. The bottom part of FIG. 1 shows two tasks T₃ and T₄ of different lengths, which can be performed on machines M₁ or M₂.

In the initial state, before the invention's process is applied, tasks T₁ and T₂ are scheduled with a certain time lag, and the production goal is to allow tasks T₂ and T₃ to be performed on machines M₁ and M₂.

Among the additional constraints or aims of the example is the fact that task T₄ can only be executed on machine M₂, whereas task T₃ may be executed equally on either of the machines M₁ or M₂.

In accordance with the invention, the first stage consists in setting up a collaborative network between the various agents liable to share a common resource. In this instance, tasks T₁-T₄ are likely to share the common uptime resource of machines M₁ and M₂. The collaborative network is formed by listing the possibilities of exchanging a given resource between tasks, in other words switching the uptimes of machine M₁ or M₂. In this way, the network expresses all the relations between agents, and constitutes an infrastructure whereby the various agents will express their satisfaction rating in respect of each switchover during the negotiations.

FIG. 2 illustrates the various possible movements with regard to the configuration shown in FIG. 1. Each agent, namely tasks T₁-T₄ as well as the empty tasks V₁ and V₂, is linked to other tasks, which means they can exchange their execution schedules on one of the machines M₁, M₂. More precisely, its links are illustrated by the Δ symbol. The summit of the triangle points to the agent, namely the task whose place will be taken by the other agent connected by the same link. For instance, relation R₁ indicates that task T₄ can take place instead of task V₂, because both tasks V₂-T₄ are connected via the network. Each tree in the network, the origin of which is an agent, may have several branches. Branches J, symbolized by simple nodes, namely without any additional graphic symbol, are alternative conditions, in other words logical “OR”s. The J₃ junctions or nodes, shown as double arcs of a circle, are cumulative conditions, namely logical “AND”s. Relations R₂ and R₃ indicate that tasks T₁ and T₃ can take the place of empty task V₂. As for task T₁, one can choose between it taking the place of task V₂, via relation R₂, or even that of task T₂ via relation R₄ if, by virtue of the cumulative condition of J₃, task T₃ takes the place of task T₁ via relation R₆. Similarly, task T₂ can take the place of task V₁ via relation R₅, if task T₁ replaces task T₂ via relation R₄.

Naturally, agents may be linked by other relations to other agents, who are not shown inasmuch as they play no part in resolving the particular problem of planning execution of the four tasks T₁-T₄. Furthermore, for this type of problem, one could show certain time constraints between the tasks to be assigned to the machines.

As shown in FIG. 6, the next stage consists in performing an iterative resolution process S₂, S₃, S₄ in which each agent perceives the satisfaction rating ascribed to each relation by the other agents with a view to altering and either validating or invalidating the relation in question.

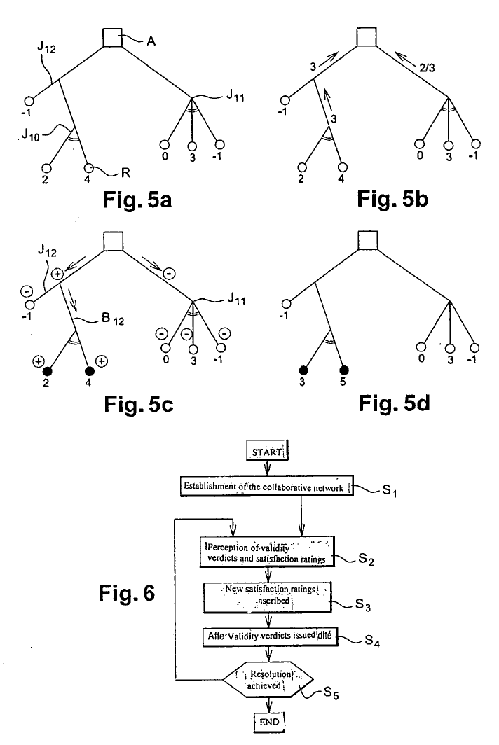

In this resolution process, an iterative succession of stages is performed, in which each agent perceives his satisfaction rating S₂, according to the validity verdicts on the various relations he is part of, and which make up the leaves of the tree of which he is the root. More precisely, the various basic stages unfold in a cycle shown in FIGS. 5 to 5d. At the initial stage, each agent A (symbolized by a square) perceives the satisfaction rating ascribed to each relation by all the agents linked to this relation. So, as can be seen in FIG. 5a, each relation R is represented by an extremity (symbolized by a circle) of the tree, to which a numeric value is assigned.

At each node J₁₀, J₁₁, J₁₂ of this tree, a calculation is performed according to the downstream nodes and/or extremities, involving a mass of variables, such as the detection of minimums, maximums or mean values. In the instance shown in FIG. 5b, each “and”-type node J₁₀, J₁₁ is assigned the mean value of the values at the extremities of the downstream branches. This corresponds to stage S₃ in FIG. 6. Similarly, the “or”-type nodes J₁₂ are assigned the maximum value of the values at the downstream nodes and extremities. Of course the invention also covers other variants, in which the numeric values, which may be weighted, can be computed differently. More generally, satisfaction ratings may be expressed as codes that are not necessarily numeric.

Subsequently, each agent performs an action on the tree of which he is the origin, by selecting certain contracts that can satisfy him, marking his environment to encourage reciprocal selection of the contracts, in other words by issuing a valid verdict, according to stage S₄ of FIG. 6. In practice, the two stages S₃ and S₄ can be executed simultaneously.

So, as FIG. 5c shows, each agent first selects the sub-trees having the highest values, and in doing so increases the satisfaction rating of each of the tree's leaves, symbolized by ⊕, decreasing that of the other branches accordingly (symbolized by ⊖)). So, for “or” nodes, the downstream branch B₁₂ with the highest rating sees its rating increased and propagate. Conversely, the “and”-type J₁₁ nodes see their branches' satisfaction ratings increase or decrease.

Furthermore, as shown in FIG. 5c, the contracts (or satisfactory relations) are validated by the agent in question, who in so doing informs his environment of his preferences regarding the sharing of critical resources. In FIGS. 5c and 5d, the contracts or relations validated by the agent are symbolized by a solid black circle.

At each cycle, each agent thus perceives the validation verdicts for the relations matching the nodes of potential collaboration with other agents and, as explained earlier, marks his environment according to the selections he prefers.

This sequence of stages S₂, S₃, S₄ continues until overall resolution is achieved according to test S₅.

As shown in FIG. 3, the resolution process applied to the example in FIGS. 1 and 2 leads to the validation of relations R₁, R₄, R₅ and R₆, in such a manner that task T₃ will replace task T₁ which in turn will replace task T₂ on machine M₂, which will therefore take the place of empty task V₁ on machine M₁. Task T₄ will be assigned to take the place of empty task V₂ on machine M₂, so as to achieve the organizational configuration shown in FIG. 4.

The resolution as described above reinforces links having high satisfaction ratings. However, in a manner not illustrated herein, a fraction of near-random behaviour can be instilled into the resolution process with a view to encouraging the emergence of solutions that are in theory incompatible with a would-be satisfactory solution, but only locally; in which case, satisfaction ratings computed using a determinist law (by calculating a maximum or minimum value, for instance) may be upset by a random law. This could for instance consist in randomly selecting one of the sub-trees that would not have been selected by the determinist law. This approach favours an exploratory process aimed at averting the deadlocks arising when satisfactory solutions appear only locally rather than globally.

As we have demonstrated, the invention presents numerous advantages, inasmuch as it allows complex exchanges between multiple agents through negotiations supported by the environment, commonly termed stigmergic negotiations; indeed, rather than negotiating directly with one another, the agents negotiate by marking their local environment, in other words by issuing satisfaction ratings and validity verdicts. This type of stigmergic communication can be likened to that of social insects, which communicate by marking their environment, for instance through chemical structures such as pheromones. This process proves to be advantageous insofar as it can be adapted to many situations and applied to different types of systems to determine a satisfactory solution (or solutions if they exist) from a global standpoint.

The invention can be used to work out complex solutions to difficult problems, problems that are still hard to resolve through other MAS approaches. Thanks to this invention, the robust, flexible and decentralized features specific to multiagent systems can therefore be used for critical resource sharing problems.

One advantage of the invention is that it proposes a generic approach. The collaborative network can be used to represent a wide variety of critical resource sharing problems, which can be resolved on the basis of the same agent behaviours thanks to the system's capacity to organize itself.

1. A method of assigning a set of resources to multiple agents using the said resources, comprising:
an initial stage, consisting in setting up a collaborative network between agents, the said network expressing all the relations between agents liable to share at least one given resource through one or more coordinated actions, the said network evaluating a degree of satisfaction for each agent according to all the validity verdicts ascribed by each agent to the relations in which they are engaged;
a resolution stage, comprising a series of iterative basic stages during which each agent:
perceives a satisfaction rating ascribed to each relation by all the agents linked by the said relation;
alters the said satisfaction rating;
validates or invalidates the relation in question,
the series of basic stages continuing until predefined state of resolution is achieved.

2. A method as claimed in claim 1 whereby the collaborative network is represented by a heterogeneous graph, each agent being associated with a tree of which he is the origin.

3. A method as claimed in claim 2 whereby the trees of the different agents are interlinked through their leaves.

4. A method as claimed in claim 1 whereby satisfaction ratings evolve according to a determinist function of the perceived degrees of satisfaction.

5. A method as claimed in claim 1 whereby evolving satisfaction ratings reinforce the positive validity ascribed to the relation in question.

6. A method as claimed in claim 1 whereby satisfaction ratings evolve through a function that includes a random factor.

7. A method as claimed in claim 1 whereby satisfaction ratings evolve according to a law based on assignment aims.

8. A method as claimed in claim 7 whereby the law evolves over time.

9. A method as claimed in claim 1 whereby one detects subsets of agents, all linked by relations showing positive validity verdicts for all the agents linked by the said relation.

10. A method as claimed in claim 1 whereby a predetermined degree of resolution is achieved by executing a predetermined number of basic stages.

11. A method as claimed in claim 1 whereby a predetermined degree of resolution is achieved when a predetermined length of time has elapsed.

12. A method as claimed in claim 1 whereby a predetermined degree of resolution corresponds to an evaluation of the positive satisfaction rating of a predefined fraction of agents.
